(19) United States
(12) Patent Application Publication
(10) Pub. No.: US 2001/0023472 A1
(43) Pub. Date: Sep. 20, 2001

(54) DATA STORAGE CONTROL METHOD AND APPARATUS FOR EXTERNAL STORAGE DEVICE USING A PLURALITY OF FLASH MEMORIES

(76) Inventors: NORIKO KUBUSHIRO, HITACHINAKA-SHI (JP); YUJI SUGAYA, HITACHINAKA-SHI (JP)

Correspondence Address: KENYON & KENYON, 1500 K STREET, N.W., SUITE 700, WASHINGTON, DC, 20005, US

(21) Appl. No.: 09/174,100

(22) Filed: Oct. 16, 1998

(30) Foreign Application Priority Data
Oct. 21, 1997 (JP) 9-288576

(51) Int. Cl. G06F 12/00

(52) U.S. Cl. 711/103

(57) ABSTRACT

The present invention is to realize a data storage control method and apparatus for an external storage device using flash memories. The method and apparatus can eliminate the data erasure waiting time, eliminating the calculation of the erasure numbers of flash memories, elongating the life-time of the flash memories. Data is stored sequentially from a first flash memory for rewrite data to a third flash memory for rewrite data. When there is no vacant area in the third flash memory for rewrite data, a CPU instructs a first flash memory for garbage collection among the first and second flash memories for garbage collection to perform the garbage collection of the first flash memory for rewrite data. When a host computer issues a write access request, the write process is performed in the first flash memory for garbage collection with the first priority. When the garbage collection of the first flash memory for rewrite data has been completed, the garbage collection of the second flash memory for rewrite data is performed by the second flash memory for garbage collection. At the time of performing the garbage collection of the second flash memory for rewrite data, the data of the first flash memory for rewrite data is simultaneously erased. The first flash memory for garbage collection is changed into a flash memory for rewrite data by the CPU. Upon completion of the garbage collection of the second flash memory for rewrite data, the data thereof is simultaneously erased and the second flash memory for garbage collection is changed into a flash memory for rewrite data. Then, the garbage collection of the third flash memory for rewrite data is performed in the similar manner.

### BACKGROUND OF THE INVENTION

1. Field of the Invention

The present invention relates to a data control method for an external storage device using a memory such as a flash memory in which the rewritable number of times is limited and, more particularly, relates to a data storage control method and apparatus which intends to enhance the accessing speed and elongate the lifetime of the external storage device by controlling the rewritable number of times.

2. Description of the Prior Art

Recently, a flash memory has been noticed as a non-volatile memory which is limited in the rewritable number of times but electrically rewritable and hence the flash memory has been employed in a portable device, a memory card, or the like. In the flash memory, however, the data erasure operation can only be performed simultaneously on a block unit basis in a range of 512 bytes to 64 Kbytes and the rewritable number of times is limited in a range of about 10⁴ to 10⁵.

Further, in the flash memory, at the time of erasing the data of an erasure block within the flash memory, effective data within the erasure block is also erased. In order to prevent such an erasure of effective data, the garbage collection for rewriting the effective data into another storage area is required. However, in the case of erasing data on a block unit basis, since the erasing operation for erasing an erasure block takes a long time, data of another erasure block within the same flash memory can not be accessed during the erasure operation.

Furthermore, since a flash memory is limited in its rewritable number of times, the lifetime of the flash memory itself expires when the lifetime of one storage area of the flash memory expires due to the fact that the rewritable number of times of the one storage area reaches a predetermined limit number. Thus, in an external storage device using a plurality of flash memories, the lifetime of the external storage device itself expires when the lifetime of one of the plurality of the flash memories expires due to the fact that the rewritable number of times of the one flash memory reaches a predetermined limit number.

Accordingly, in the prior art, in order to elongate the lifetime of an external storage device using a flash memory, data stored in an erasure block with a smaller erasure number of times is exchanged for data stored in an erasure block with a larger erasure number of times thereby to average the erasure number times among the respective erasure blocks.

An example of such a conventional technique is disclosed in JP-A-5-27924 entitled “External storage system using a semiconductor memory and a control method thereof”.

In such a conventional technique, however, in order to average the erasure number of times of the respective erasure blocks, it is required to count the erasure number of times of the respective erasure blocks and to calculate the differences of the erasure number of times among the respective erasure blocks. Accordingly, the conventional technique has a problem that much times is required for the calculation and hence it becomes difficult to execute other processing.

### SUMMARY OF THE INVENTION

An object of the present invention is to provide a data storage control method and apparatus for an external storage device using a plurality of flash memories which can eliminate the aforesaid problem of the conventional technique.

Another object of the present invention is to provide a data storage control method and apparatus for an external storage device using a plurality of flash memories which can eliminate the waiting time for data erasure, eliminate the time for calculating the differences of the erasure number of times among the respective erasure blocks, and always average the erasure number of times of the flash memories thereby to elongate the lifetime of the external storage device using the flash memories.

In order to attain the aforesaid object, the present invention is arranged in the following manner.

(1) According to an aspect of the present invention, in a data storage control method for an external storage device using a plurality of flash memories each of which is limited in a rewrite number of times, an erasure block thereof is larger than a physical sector thereof for actually writing data therein and data within the erasure block is simultaneously erased,

the plurality of flash memories are classified into a predetermined number of flash memories for rewrite data for storing rewrite data applied from outside and a flash memory for garbage collection, and data from the outside is written into the flash memories for rewrite data in a write once manner;

when there is no vacant area in the flash memories for rewrite data, garbage collection is performed in which effective data within the flash memory for rewrite data is moved into the flash memory for garbage collection before erasing data within the flash memory for rewrite data, and rewrite data supplied hereinafter from the outside is written into the flash memory for garbage collection; and

after completion of movement of the effective data from the flash memory for rewrite data into the flash memory for garbage collection, data within the flash memory for rewrite data is simultaneously erased, wherein

the data erasure of the flash memory for rewrite data and data accessing to the flash memories from the outside are executed in parallel.

(2) Preferably, in the arrangement (1), at a time of completion of data erasure of the flash memory for rewrite data, the flash memory for rewrite data is changed into a flash memory serving as a flash memory for garbage collection and the flash memory for garbage collection is changed into a flash memory serving as a flash memory for rewrite data thereby to move data storage location, wherein

garbage collection is performed in the same manner as to remaining ones of the plurality flash memories for rewrite data thereby to move data storage location, and wherein

the garbage collection is repeatedly executed to rotate the data storage location in a predetermined order thereby to average data rewrite number of times of all of the flash memories.

(3) According to another aspect of the present invention, in a data storage control apparatus for an external storage device using a plurality of flash memories each of which is limited in a rewrite number of times, an erasure block thereof is larger than a physical sector thereof for actually writing data therein and data within the erasure block is simultaneously erased, the data storage control apparatus comprising:

a predetermined number of flash memories for rewrite data for storing rewrite data applied from outside in write once manner;

a flash memory for garbage collection for performing garbage collection in which effective data within the flash memory for rewrite data is moved therein; and

a data storage control means for, when there is no vacant area in the flash memories for rewrite data, performing garbage collection in which effective data within the flash memory for rewrite data is moved into the flash memory for garbage collection before erasing data within the flash memory for rewrite data, then storing rewrite data supplied hereinafter from the outside into the flash memory for garbage collection, and after completion of movement of the effective data from the flash memory for rewrite data into the flash memory for garbage collection, simultaneously erasing data within the flash memory for rewrite data, wherein the data erasure of the flash memory for rewrite data and data accessing to the flash memories from the outside are executed in parallel.

(4) Preferably, in the arrangement (3), the data storage control means changes, at a time of completion of data erasure of the flash memory for rewrite data, the flash memory for rewrite data into a flash memory serving as a flash memory for garbage collection and changes the flash memory for garbage collection into a flash memory serving as a flash memory for rewrite data thereby to move data storage location, wherein the data storage control means performs garbage collection in the same manner as to remaining ones of the plurality flash memories for rewrite data thereby to move data storage location, and repeatedly executing the garbage collection to rotate the data storage location in a predetermined order thereby to average data rewrite number of times of all of the flash memories.

Thus, the data storage control method and apparatus are arranged in a manner that a plurality of flash memories are classified into a predetermined number of the flash memories for rewrite data for storing rewrite data applied from the outside and the flash memories for garbage collection for performing the garbage collection for moving therein the effective data of the flash memory for rewrite data, and the rewrite data applied from the outside is written into the flash memory for rewrite data in the write once manner.

Accordingly, since there is no effective data in the flash memory which is under the erasure operation and in the state of the completion of the garbage collection, the parallel execution of the data accessing and the data erasure for the flash memories are possible and hence the waiting time for data erasure can be eliminated.

Further, since the data storage control method and apparatus are arranged in a manner that the rotation of the functions of the flash memories is performed in the predetermined order, it is possible not only to eliminate such a memory management for selecting a suitable memory for moving therein data of the flash memory having no vacant area among the plural flash memories but also to eliminate the calculation of the difference of the erasure number of times of the flash memories.

### BRIEF DESCRIPTION OF DRAWINGS

FIG. 1 is a schematic diagram showing an arrangement of an external storage device using flash memories to which an embodiment of the present invention is applied;

FIG. 2 is a diagram showing a method for performing data storage position rotation in the embodiment of the present invention;

FIG. 3 is a diagram showing an arrangement of a flash memory used in the embodiment of the present invention;

FIG. 4 is a diagram showing an arrangement of an erasure block of the flash memory used in the embodiment of the present invention;

FIG. 5 is a diagram showing an arrangement of a physical sector of the erasure block of the flash memory used in the embodiment of the present invention;

FIG. 6 is a diagram showing an arrangement of a mapping table used in the embodiment of the present invention;

FIG. 7 is a diagram showing data in a physical sector management area added to a physical sector;

FIG. 8 is a diagram showing data in a flash memory management area to be stored in an erasure block;

FIG. 9 is a diagram showing a method of preparing a mapping table;

FIGS. 10A to 10C are diagrams for explaining the garbage collection method required at the time of erasing data of the flash memory;

FIG. 11 is a diagram showing the comparison of data access time between the present invention and the prior art; and

FIGS. 12A and 12B are diagrams showing the data access method to the external storage device from a host computer.

### DETAILED DESCRIPTION OF THE INVENTION

An embodiment of the present invention will be described with reference to the accompanying drawings.

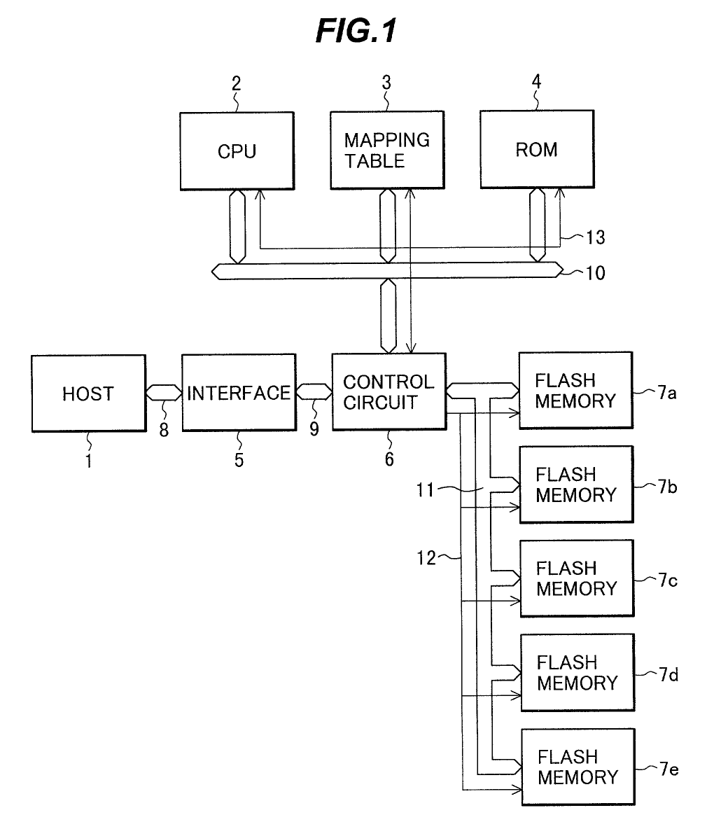

FIG. 1 is a schematic diagram showing an arrangement of an external storage device using flash memories to which an embodiment of the present invention is applied.

In FIG. 1, the external storage device includes a host computer 1, a central processing unit (CPU) 2 and a mapping table 3. The mapping table 3 makes correspondence logical sector addresses accessed by the host computer 1 with physical sector addresses representing data storage area of the flash memory.

The external storage device further includes a read only memory (ROM) 4 storing program for recovering the operation of the external storage device at the time of turning on the power supply, an interface 5 between the host computer 1 and the external storage device, a control circuit (data storage control means) 6 for delivering control signals to the CPU 2, the mapping table 3, the ROM 4 and the interface 5, and flash memories 7 serving as storage media.

Further, the external storage device includes an interface data bus 8 for connecting the host computer 1 and the interface 5, a control data bus 9 for connecting the interface 5 and the control circuit 6, and a CPU bus 10 for performing data transmission and reception among the CPU 2, the mapping table 3 and the ROM 4.

Furthermore, the external storage device includes a memory data bus 11 for performing data transmission and reception between the flash memories 7 and the control circuit 6, a memory control line 12 for transmitting signal from the control circuit 6 to the flash memories 7, and a control signal line 13 for performing signal transmission and reception among the CPU 2, the control circuit 6, the mapping table 3 and the ROM 4.

The flash memories 7 within the external storage device are classified into a flash memory for rewrite data having a capacity of 24 Mbytes and a flash memory for garbage collection having a capacity of 16 Mbytes. Each of the flash memory for rewrite data and the flash memory for garbage collection is further divided on a 8 bytes unit basis. That is, each of flash memories 7a to 7c of FIG. 1 serves as a flash memory for rewrite data having a capacity of 8 Mbytes and each of flash memories 7d to 7e of FIG. 1 serves as a flash memory for garbage collection having a capacity of 8 Mbytes.

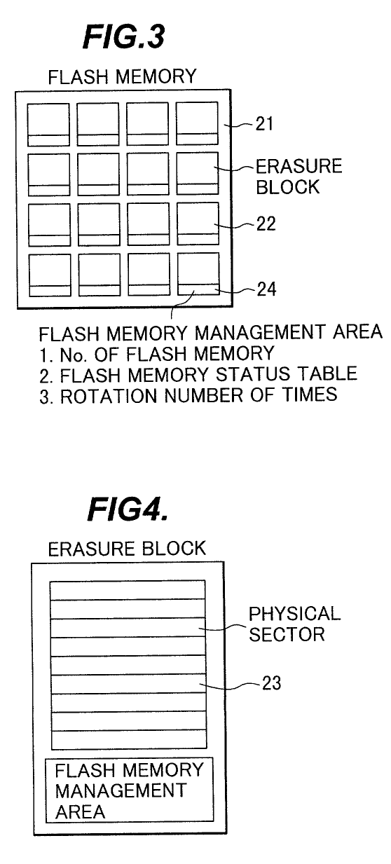

FIG. 3 is a diagram showing the arrangement of the flash memory and FIG. 4 is a diagram showing the arrangement of the erasure block of the flash memory.

In FIGS. 3 and 4 a flash memory 21 has a plurality of erasure blocks 22. Each of the erasure blocks 22 has a plurality of divided physical sectors 23 and a flash memory management area 24. The single flash memory 21 has a capacity of 2 Mbytes and each of the erasure blocks 22 of the flash memory 21 has a capacity of 64 kbytes.

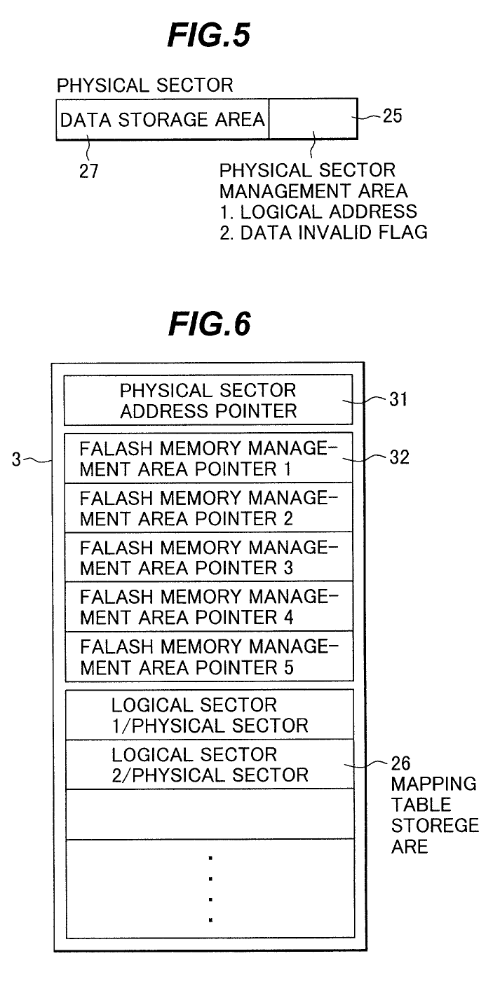

FIG. 5 is a diagram showing an arrangement of a physical sector 23 of the erasure block.

In FIG. 5, the physical sector 23 includes a physical sector management area 25 for storing information for managing data in addition to a data storage area 27. Each of the logical sector and the physical sector has the data storage area of 512 bytes and the management area of 32 bytes, that is, a capacity of 544 bytes in total. The physical sector is a unit for storing data and the logical sector is a minimum file unit to be accessed when the host computer 1 accesses the flash memories 7a to 7e.

The data width of the flash memory is 8 bits. In order to realize the data transfer of 32 bits, four flash memories are arranged in parallel. To this end, the flash memories are managed on four flash memories unit basis and so 8 Mbytes unit basis.

FIG. 6 is a diagram showing the arrangement of the mapping table.

In FIG. 6, a mapping table storage area 26 is provided so as to indicate the corresponding relation between the logical sector addresses and the physical sector addresses since the logical sector address to which the host computer 1 accesses differs from the physical address in which the data to be accessed is stored actually. The mapping table storage area is used when the host computer 1 accesses data.

The mapping table 3 is prepared at every turning-on of the power supply. When the storage location of data within the flash memory is changed, the physical addresses of the mapping table storage area 26 are rewritten from the previous physical addresses at which the data has been stored to the current physical addresses at which the data is stored.

The mapping table 3 includes a physical sector address pointer 31 indicating a leading physical address of a physical sector address to be writable next so that such a physical sector address can be found easily.

Further, the mapping table 3 includes five flash memory management area pointers 32 indicating leading physical addresses of the flash memories to be accessed so that the physical addresses storing the flash memory management areas can be found easily.

In the flash memory, since the data erasure unit is larger than the data access unit accessed by the host computer, the data erasure time is required. In view of this fact, in the flash memory, data is written in the write once manner. That is, at the time of rewriting data, data having been written is invalidated and data to be newly written is written, whereby the data erasure having been required at every data rewriting operation can be eliminated thereby to enhancing the data accessing speed.

Since the data writing operation is performed by the write once manner, the leading physical address stored in the physical sector address pointer 31 is always an address next to the address having been written.

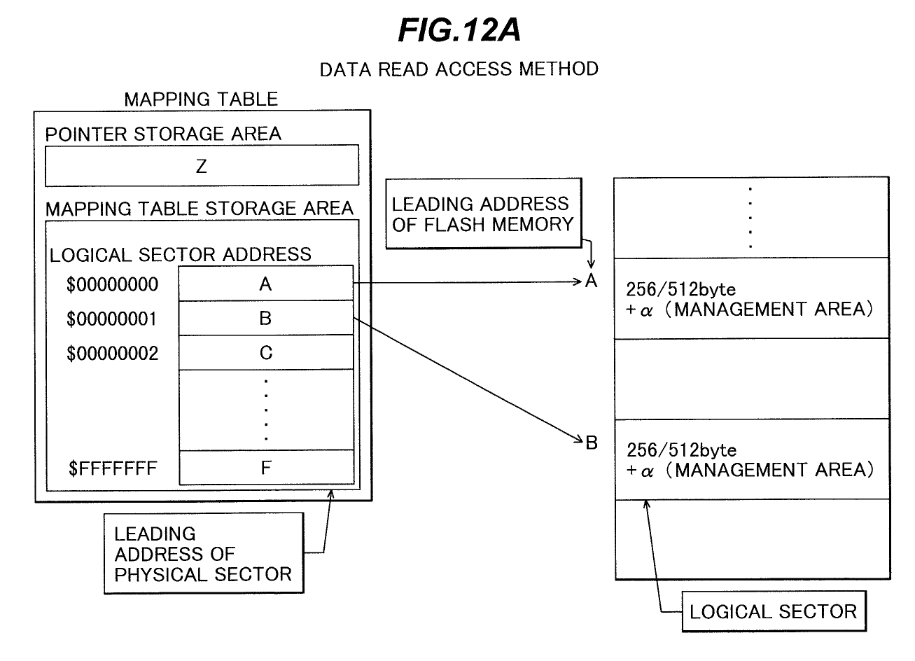

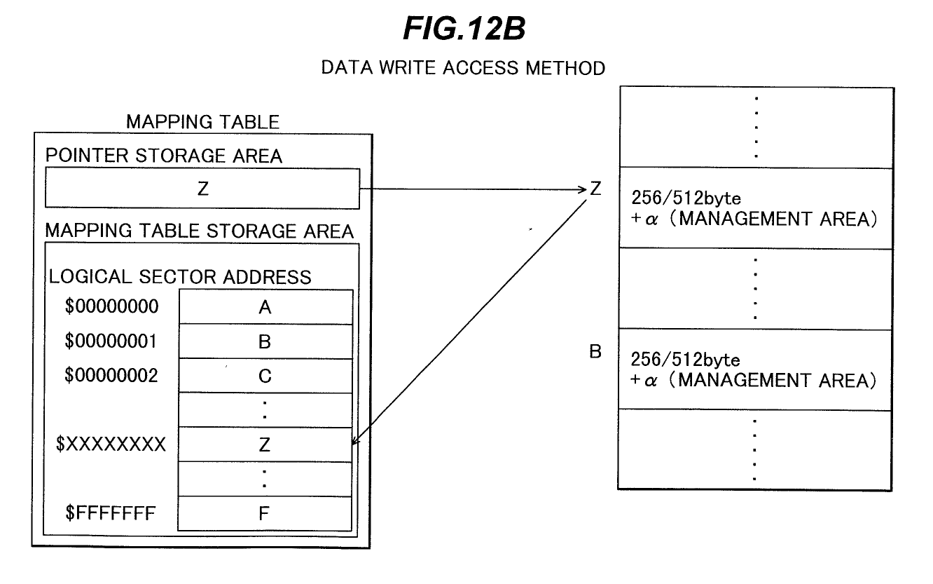

FIGS. 12A and 12B are diagrams showing the data access method to the external storage device using flash memories from the host computer 1.

As shown in FIG. 12A, when the host computer 1 performs data read accessing, the host computer sends the accessed logical sector address to the CPU 2 through the interface 5 and the control circuit 6. The CPU 2 accesses the mapping table storage area of the mapping table 3 thereby to translate the logical sector address into the physical sector address, then accesses the flash memory 7a, 7b or 7c with the physical sector address thereby to read data, and then transfers the data thus read to the host computer 1 through the interface.

As shown in FIG. 12B, when the host computer 1 issues the write access request, data is written into the flash memory for rewrite data always in the write once manner. The leading physical address to be writable next is stored into the physical sector address pointer 31 of the mapping table 3. When the host computer 1 performs data writing, the CPU 2 receives data to be written through the interface 5 and the control circuit 6 and accesses the physical sector address pointer 31 of the mapping table storage area thereby to write the data into the address of the flash memory 7 stored in the physical sector address pointer 31.

After completion of the data writing, in the mapping table 3, the physical sector address corresponding to the logical sector address is rewritten into the leading physical sector address of the data thus written. At the same time, the physical sector address pointer 31 is rewritten into a leading physical address of a physical sector address to be writable next so that next data can be written into this physical sector address.

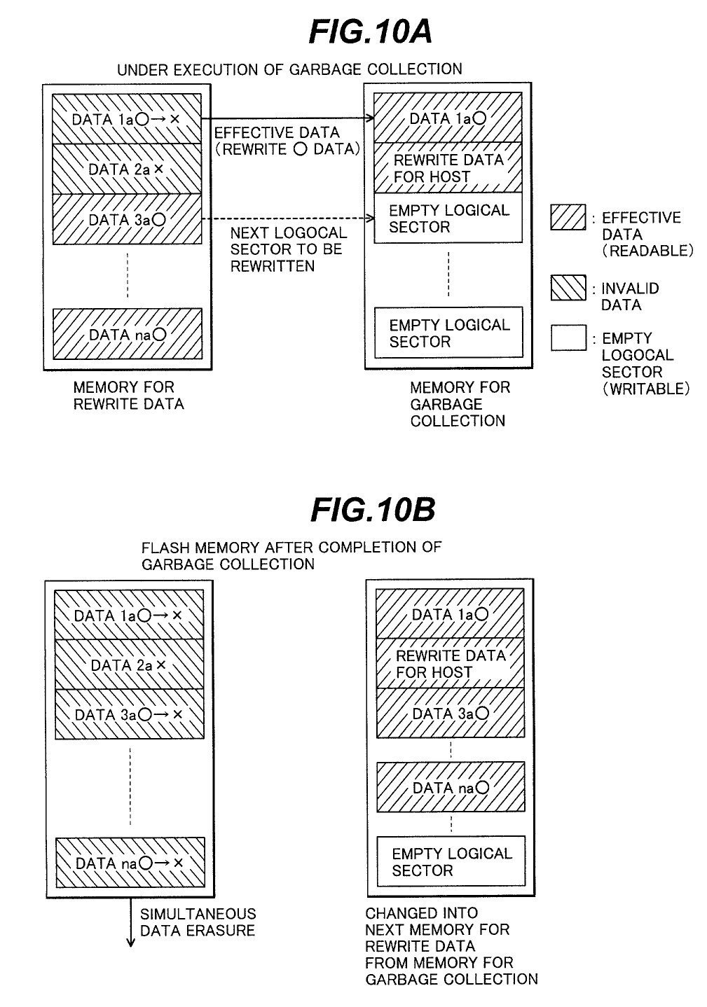

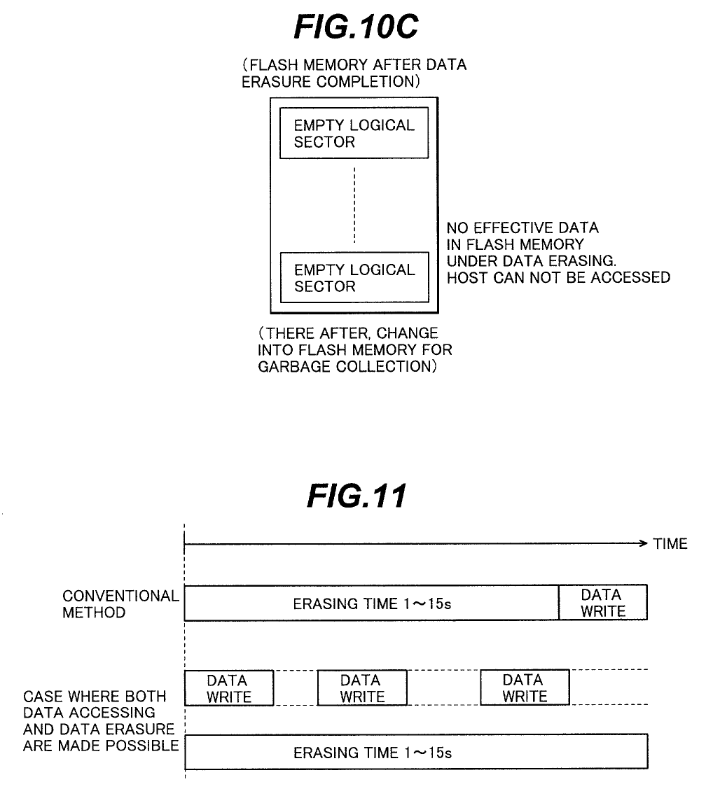

The garbage collection method required at the time of data erasure of the flash memory will be explained with reference to FIGS. 10A to 10C.

In FIGS. 10A to 10C, the flash memories 7a to 7e are classified into the flash memories 7a, 7b, 7c for rewrite data and the flash memories 7d, 7e for garbage collection. The flash memory for garbage collection is a flash memory which is required to move effective data within the flash memory for rewrite data into the flash memory for garbage collection when there is no vacant area within the flash memory for rewrite data at the time of executing data erasure.

When the flash memories 7a, 7b, 7c for rewrite data are filled with the rewrite data from the host computer 1, the CPU 2 extracts only the effective data from the flash memories through the memory control line 12 and the memory data bus 11 and write the effective data into the flash memory for garbage collection.

FIG. 10A shows the data accessing state under the execution of the garbage collection. When vacant area in the flash memories 7a, 7b, 7c for rewrite data become zero due to the write data from the host computer 1, the garbage collection is executed for the flash memories 7d, 7e for garbage collection in a manner that only the effective data is moved from the flash memories 7a, 7b, 7c for rewrite data into the flash memories for garbage collection at the interval between the accessing operations of the host computer 1.

The data write accessing from the host computer 1 is also executed for the flash memories 7d, 7e for garbage collection. In this case, however, the effective data within the flash memories 7a, 7b, 7c for rewrite data can be accessed for data reading.

FIG. 10B shows the states of the flash memories after the completion of the garbage collection. The flash memories 7a, 7b, 7c for rewrite data from which effective data is completely removed are subjected to the simultaneous data erasure.

The flash memory for garbage collection storing data subjected to the garbage collection is changed into the flash memory serving as a next flash memory for rewrite data. The flash memory for rewrite data having been subjected to the simultaneous data erasure shown in FIG. 10C will serve as a next flash memory for garbage collection.

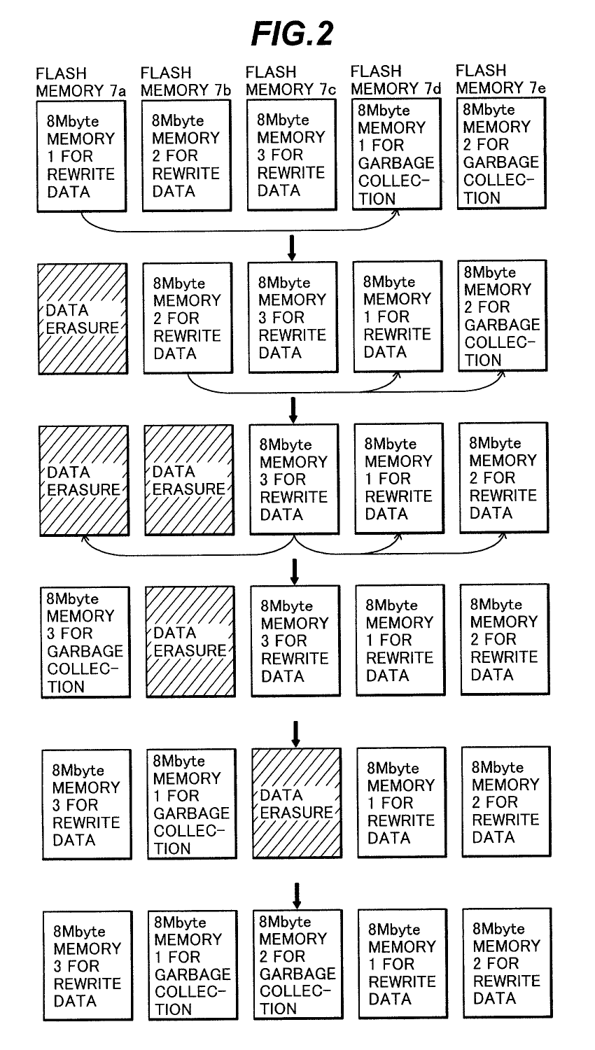

The method for performing data storage position rotation for realizing the elongation of the lifetime of the flash memory will be described with reference to FIG. 2.

In FIG. 2, it is supposed that the flash memory 7a is a flash memory 1 for rewrite data, the flash memory 7b is a flash memory 2 for rewrite data, the flash memory 7c is a flash memory 3 for rewrite data, the flash memory 7d is a flash memory 1 for garbage collection, and the flash memory 7e is a flash memory 2 for garbage collection.

The flash memories 1, 2, 3 for rewrite data store data sequentially in the order from the flash memory 1 to the flash memory 3. When there is no vacant area in the flash memory 3 for rewrite data, the CPU 2 performs the garbage collection for the flash memory 1 for rewrite data with respect to the flash memory 1 for garbage collection.

When the host computer 1 issues the data write accessing at the time of performing the garbage collection with respect to the flash memory 1 for garbage collection, the data write accessing processing is performed prior to the execution of the garbage collection in a manner that the data is written into the flash memory 1 for garbage collection. Upon the completion of the garbage collection for the flash memory 1 for rewrite data, the garbage collection for the flash memory 2 for rewrite data is performed with respect to the flash memory 1 for garbage collection or the flash memory 2 for garbage collection.

At the time of performing the garbage collection for the flash memory 2 for rewrite data, simultaneously, the data erasure of the previous flash memory 1 for rewrite data is performed in parallel. The flash memory management area of the flash memory 1 for garbage collection is rewritten by the CPU 2 and so the flash memory 1 for garbage collection is changed to serve as the flash memory 1 for rewrite data. The data to be moved from the flash memory for rewrite data in the garbage collection operation is always moved and stored in the flash memory for the garbage collection in the order from the flash memory 1 for garbage collection to the flash memory 2 for garbage collection.

Upon the completion of the garbage collection for the flash memory 2 for rewrite data, the simultaneous data erasure is performed with respect to the flash memory 2 for rewrite data like the flash memory 1 for rewrite data, then the flash memory 2 for garbage collection is changed to serve as the flash memory 2 for rewrite data. Thereafter, the garbage collection is performed with respect to the flash memory 3 for rewrite data in the same manner.

Since the rotation of the functions of the flash memories is performed in the predetermined order in this manner, the present invention is able to not only eliminate such a memory management for selecting a suitable memory for moving therein data of the flash memory having no vacant area but also eliminate the calculation of the difference of the erasure number of times of the respective flash memories.

When there is a vacant area in the flash memory 1 for garbage collection or the flash memory 2 for garbage collection, the data movement is executed at the vacant area thereof. However, when there is no vacant area in neither of the flash memory 1 for garbage collection nor the flash memory 2 for garbage collection, after the completion of the data erasure of the previous flash memory 1 for rewrite data, data is moved into the previous flash memory 1 for rewrite data. In this case, the previous flash memory 1 for rewrite data is changed to serve as the flash memory 3 for garbage collection to be used for the next garbage collection. Like the previous flash memories 1, 2 for rewrite data, when the garbage collection is completed as to the flash memory 3 for rewrite data, data erasure is performed as to the flash memory 3 for rewrite data and the flash memory 3 for garbage collection is changed in its status to serve as the flash memory 3 for rewrite data.

Further, the previous flame memories 2, 3 for rewrite data are changed in theirs statuses to serve as the flash memories 1, 2 for garbage collection, respectively.

That is, when data of 24 Mbytes is written into the flash memories, the garbage collection is executed and then the data storage location is rotated.

In accordance with the rotation of the data storage location, it is required to rewrite the status table of the flash memory management area 24. The rewriting operation of the flash memory management area 24 is performed also in the write once manner.

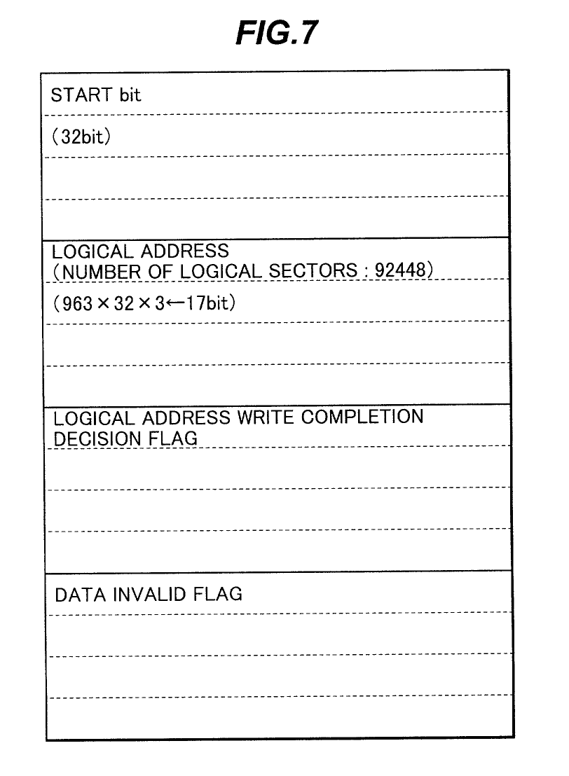

Explanation will be made as to the physical sector management area, the flash memory management area and the mapping table necessary for the data rotation with reference to FIGS. 7 to 9.

The contents of the physical sector management area 25 will be explained in detail with reference to FIG. 7.

At the time of writing data into the flash memory from the host computer 1, a value different from the initial value of the flash memory is written into the physical sector management area as a start bit in order to determine to which location of the flash memory the data is written, at the time of turning on the power supply.

Since the address number accessed by the host computer 1 differs from the physical sector address actually stored in the flash memory, a logical address which is an address accessed by the host computer 1 is written into the physical sector.

A logical address write completion decision flag is provided in order to indicate whether or not all logical addresses of information within the management area have been written. A data invalid flag is provided in order to mark “invalid” on previous unnecessary data (that is, data having been rewritten) when data of the logical sector is rewritten.

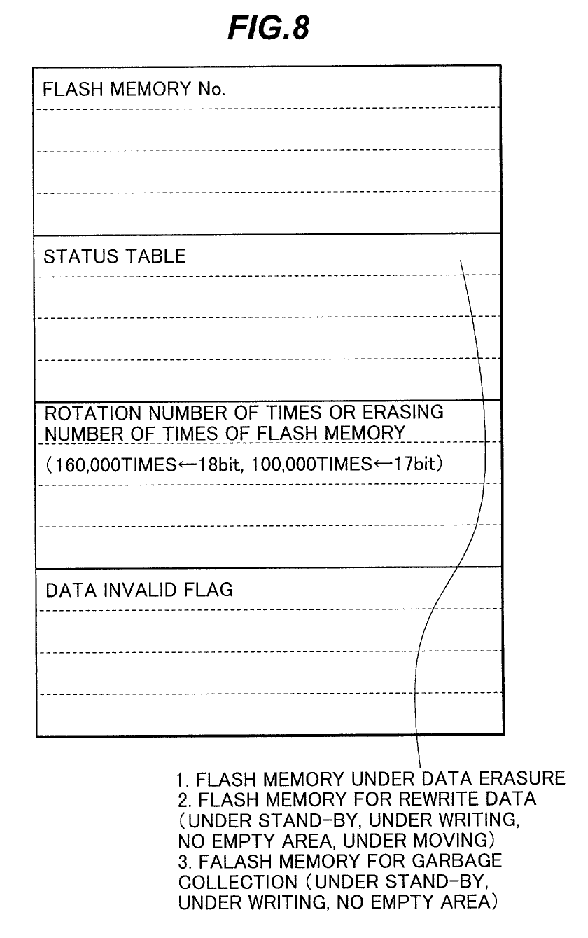

The contents of the flash memory management area will be explained with reference to FIG. 8.

The flash memory management area stores therein a flash memory number, a status table, a rotation number of times and a data invalid flag. Since the management area of the flash memory is also erased at the time of data erasure, the flash memory management area is stored in another flash memory. Thus, in order to distinguish from the management area of the storage destination, the flash memory number is provided.

The status table indicates the status of the flash memory. The statuses of the flash memory are classified into six statuses, that is, under stand-by state of data writing of a flash memory for rewrite data, under data writing status of a flash memory for rewrite data, under execution status of garbage collection of a flash memory for rewrite data, under data erasure status of a flash memory for rewrite data, under data stand-by status of a flash memory for garbage collection, and under data rewrite status of a flash memory for garbage collection. Such status can be identified by the status table.

The rotation number of times represents that how many times the data rotation has been effected in order to change the data storage location in the flash memories within the external storage device. Since the flash memory is not limited in its data rewrite number of times, it is useful to indicate the rewrite number of times of the flash memory by counting the rotation number of times of the flash memory. In the case where the management area is required to be rewritten, it is useful to employ a flag representing that the data is invalid is written as the invalid flag to indicate such old data without erasing the data of the flash memory.

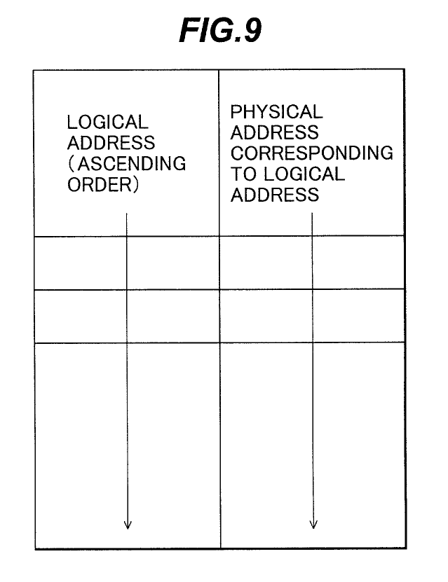

FIG. 9 is a diagram showing the method of preparing the mapping table. In the mapping table, logical addresses are arranged in ascending order and physical addresses corresponding to the logical addresses are written. In order to store the table into a RAM, the mapping table 3 is recovered by accessing the physical sector management area of the physical sector at the time of turning-on of the power supply.

However, if data rewriting is performed and power supply failure is occurred before setting the data invalid flag, there may be two data representing the same logical address when the data recovering operation is executed at the time of turning-on of the power supply. In such a case, when such two data exist within the same flash memory, the data at the latter address between the two data can be recognized as new data since the data is written in the write once mode. In contrast, when such two data exist within the different flash memories, it is possible to determine new data between the two data from the statuses of the flash memory management areas of these flash memories.

For example, when the same data exists in both the flash memory for rewrite data and the flash memory for garbage collection, the data within the flash memory for garbage collection is new data since the data within the flash memory for garbage collection is data having been transferred from the flash memory for rewrite data. The data of the flash memory for rewrite data is simultaneously erased after the completion of the garbage collection.

FIG. 11 is a diagram showing the comparison of data access time between the conventional garbage collection method and the garbage collection method according to the embodiment of the present invention which enables the parallel execution of the data accessing and the data erasure. In the conventional garbage collection method, since the data erasure is executed at the erasure block within the flash memory, data accessing can not be performed as to the flash memory under the data erasure operation. Thus, the data accessing to the flash memory is performed after the execution of the data erasure.

In contrast, according to the present invention, since the garbage collection is executed between the flash memory for rewrite data and the flash memory for garbage collection, the effective data does not exist within the flash memory under the erasing operation, so that the parallel execution of the data accessing and the data erasure for the flash memories is possible.

Further, since the movement of the data storage location is performed while performing the garbage collection, unnecessary data can be removed. Thus, a vacant sector appears at the time of the completion of the data movement, so that data can be written into the vacant sector.

Accordingly, according to the embodiment of the present invention, since no effective data exists in the flash memory under the erasure operation, the parallel execution of the data accessing and the data erasure for the flash memories is possible and hence the waiting time for data erasure can be eliminated. Further, since the rotation of the functions of the flash memories is performed in the predetermined order, it is possible not only to eliminate such a memory management for selecting a suitable memory for moving therein data of the flash memory having no vacant area among the plural flash memories but also to eliminate the calculation of the difference of the erasure number of times of the flash memories.

Accordingly, the data storage control method and apparatus for an external storage device using a plurality of flash memories can be realized which can always average or uniform the erasure number of times of the flash memories and elongate the lifetime of the external storage device.

As described above, since the present invention is arranged in the aforesaid manner, the present invention has the following technical advantages.

The data storage control method and apparatus for an external storage device using a plurality of flash memories can be realized which can eliminate the waiting time for data erasure, eliminate the time for calculating the differences of the erasure number of times among the flash memories, and always average the erasure number of times of the flash memories thereby to elongate the lifetime of the external storage device.

That is, the data storage control method and apparatus are arranged in a manner that a plurality of flash memories are classified into a predetermined number of the flash memories for rewrite data for storing rewrite data applied from the outside and the flash memories for garbage collection for performing the garbage collection for moving therein the effective data of the flash memory for rewrite data, and the rewrite data applied from the outside is written into the flash memory for rewrite data in the write once manner.

Accordingly, since there is no effective data in the flash memory which is under the erasure operation and in the state of the completion of the garbage collection, the parallel execution of the data accessing and the data erasure for the flash memories are possible and hence the waiting time for data erasure can be eliminated.

Further, since the data storage control method and apparatus are arranged in a manner that the rotation of the functions of the flash memories is performed in the predetermined order, it is possible not only to eliminate such a memory management for selecting a suitable memory for moving therein data of the flash memory having no vacant area among the plural flash memories but also to eliminate the calculation of the difference of the erasure number of times of the flash memories. Furthermore, the erasure number of times of the flash memories can be averaged and the lifetime of the external storage device using the flash memories can be elongated.

What is claimed is:

1. A data storage control method for an external storage device using a plurality of flash memories each of which is limited in a rewrite number of times, an erasure block thereof is larger than a physical sector thereof for actually writing data therein and data within the erasure block is simultaneously erased, said data storage control method comprising the steps of:
classifying said plurality of flash memories into a predetermined number of flash memories for rewrite data for storing rewrite data applied from outside and a flash memory for garbage collection, and writing data from the outside into said flash memories for rewrite data in a write once manner;
when there is no vacant area in said flash memories for rewrite data, performing garbage collection in which effective data within said flash memory for rewrite data is moved into said flash memory for garbage collection before erasing data within said flash memory for rewrite data, and storing rewrite data supplied hereinafter from the outside into said flash memory for garbage collection; and
after completion of movement of the effective data from said flash memory for rewrite data into said flash memory for garbage collection, simultaneously erasing data within said flash memory for rewrite data, wherein
the data erasure of said flash memory for rewrite data and data accessing to said flash memories from the outside are executed in parallel.

2. A data storage control method according to claim 1, wherein
at a time of completion of data erasure of said flash memory for rewrite data, said flash memory for rewrite data is changed into a flash memory serving as a flash memory for garbage collection and said flash memory for garbage collection is changed into a flash memory serving as a flash memory for rewrite data thereby to move data storage location, wherein
garbage collection is performed in the same manner as to remaining ones of said plurality flash memories for rewrite data thereby to move data storage location, and wherein
the garbage collection is repeatedly executed to rotate the data storage location in a predetermined order thereby to average data rewrite number of times of all of said flash memories.

3. A data storage control apparatus for an external storage device using a plurality of flash memories each of which is limited in a rewrite number of times, an erasure block thereof is larger than a physical sector thereof for actually writing data therein and data within the erasure block is simultaneously erased, said data storage control apparatus comprising:
a predetermined number of flash memories for rewrite data for storing rewrite data applied from outside in write once manner;
a flash memory for garbage collection for performing garbage collection in which effective data within said flash memory for rewrite data is moved therein; and
a data storage control means for, when there is no vacant area in said flash memories for rewrite data, performing garbage collection in which effective data within said flash memory for rewrite data is moved into said flash memory for garbage collection before erasing data within said flash memory for rewrite data, then storing rewrite data supplied hereinafter from the outside into said flash memory for garbage collection, and after completion of movement of the effective data from said flash memory for rewrite data into said flash memory for garbage collection, simultaneously erasing data within said flash memory for rewrite data, wherein the data erasure of said flash memory for rewrite data and data accessing to said flash memories from the outside are executed in parallel.

4. A data storage control apparatus according to claim 3, wherein
said data storage control means changes, at a time of completion of data erasure of said flash memory for rewrite data, said flash memory for rewrite data into a flash memory serving as a flash memory for garbage collection and changes said flash memory for garbage collection into a flash memory serving as a flash memory for rewrite data thereby to move data storage location, and wherein
said data storage control means performs garbage collection in the same manner as to remaining ones of said plurality flash memories for rewrite data thereby to move data storage location, and repeatedly executing the garbage collection to rotate the data storage location in a predetermined order thereby to average data rewrite number of times of all of said flash memories.
